(19) United States
(12) Patent Application Publication
(10) Pub. No.: US 2022/0281310 A1
(43) Pub. Date: Sep. 8, 2022

(54) DRIVE DEVICE

(71) Applicant: NIDEC CORPORATION, Kyoto (JP)

(72) Inventors: Keisuke NAKATA, Kyoto (JP); Yuki ISHIKAWA, Kyoto (JP)

(21) Appl. No.: 17/685,384

(22) Filed: Mar. 3, 2022

(30) Foreign Application Priority Data
Mar. 8, 2021 (JP) 2021-036146

(51) Int. Cl. B60K 7/00; B60K 11/02; F01M 1/02; F01M 1/12; F16H 57/04

(52) U.S. Cl. CPC B60K 7/0007; B60K 11/02; F01M 1/02; F01M 1/12; F16H 57/0413; F16H 57/0424; F16H 57/0426; F16H 57/043; F16H 57/0436; F16H 57/0441; F16H 57/045; F16H 57/0457; F16H 57/0471; F16H 57/0476; F16H 57/0495; B60K 2001/001

(57) ABSTRACT

A housing of a drive device includes a refrigerant flow path through which a refrigerant flows. The refrigerant flow path includes a first flow path, a second flow path, and a connection flow path. The refrigerant to be sent from a pump flows through the first flow path. The refrigerant to be supplied to the motor portion flows in the second flow path. The first flow path and the second flow path are connected to the connection flow path. At least a part of the connection flow path is disposed in the motor accommodation space for accommodating the motor portion.

### CROSS-REFERENCE TO RELATED APPLICATIONS

The present invention claims priority under 35 U.S.C. § 119 to Japanese Patent Application No. 2021-036146 filed on Mar. 8, 2021, the entire content of which is incorporated herein by reference.

### FIELD OF THE INVENTION

The present invention relates to a drive device.

### BACKGROUND

Conventionally, a drive device having a refrigerant flow path for cooling a motor inside a housing is known.

Conventionally, a plurality of members constituting a housing of a drive device may have flow paths for a refrigerant, respectively. When the flow paths are connected to each other, it is necessary to seal a connection portion between the flow paths formed in the separate members in order to prevent leakage of the refrigerant.

### SUMMARY

An exemplary drive device of the present invention includes a motor portion and a housing that accommodates the motor portion. The motor portion includes a rotor and a stator. The rotor includes a shaft which is rotatable about a rotation axis extending along an axial direction. The shaft is rotatable about the rotation axis extending along the axial direction. The stator is disposed radially outward of the rotor. The housing includes a first housing, a second housing, a motor accommodation space, and a refrigerant flow path. The first housing extends in the axial direction, and surrounds the stator. The second housing is attached to one axial end portion of the first housing. The motor accommodation space is surrounded by the first housing and the second housing to accommodate the motor portion. The refrigerant flows in the refrigerant flow path. The refrigerant flow path includes a first flow path disposed in the first housing, a second flow path disposed in the second housing, and a connection flow path. The refrigerant to be sent from the pump flows through the first flow path. The refrigerant to be supplied to the motor portion flows through the second flow path. The first flow path and the second flow path are connected to the connection flow path. At least a part of the connection flow path is disposed in the motor accommodation space.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic configuration view of a drive device viewed from a Z axis direction;

FIG. 2 is a schematic configuration view of the drive device viewed from an X axis direction;

FIG. 3 is a schematic configuration view of the drive device viewed from a Y axis direction;

FIG. 4 is a perspective view of the drive device;

FIG. 5 is a schematic view showing an example of a vehicle having the drive device;

FIG. 6 is an exploded perspective view of a housing;

FIG. 7 is a schematic view showing a configuration example of an oil passage on a motor side;

FIG. 8A is a first preferred modification of a connection pipe;

FIG. 8B is a second preferred modification of the connection pipe; and

FIG. 9 is a connection example of a conventional flow path.

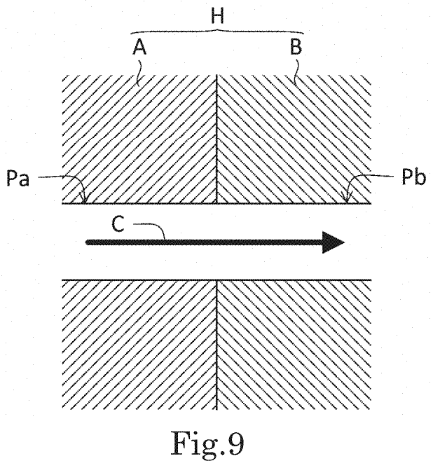

### DETAILED DESCRIPTION

Hereinafter, exemplary preferred embodiments will be described with reference to the drawings.

The following description will be made with the direction of gravity being partitioned based on a positional relationship in the case where a drive device 1 is mounted in a vehicle 200 located on a horizontal road surface. In addition, in the drawings, an XYZ coordinate system is shown appropriately as a three-dimensional orthogonal coordinate system. In the XYZ coordinate system, the Z axis direction indicates the vertical direction (i.e., up-down direction). The +Z direction is upward (vertically upward opposite to the gravity direction), and the −Z direction is downward (vertically downward in the same direction as the direction of gravity). The “Z axis direction” in the following description is an example of the “second direction” of the present invention. In each component, an end portion upward is referred to as an “upper end portion”, and the position of the upper end portion in the axial direction is referred to as an “upper end”. An end portion downward is referred to as a “lower end portion”, and the position of the lower end portion in the axial direction is referred to as a “lower end”. Among surfaces of each component, a surface facing the upper side is referred to as an “upper surface”, and a surface facing the lower side is referred to as a “lower surface”.

The X axis direction is a direction orthogonal to the Z axis direction and shows the front-rear direction of a vehicle 200 in which the drive device 1 is mounted. The “X axis direction” in the following description is an example of the “first direction” of the present invention. The +X direction is the front of the vehicle 200, and the −X direction is the rear of the vehicle 200. However, the +X direction can be the rear of the vehicle 200, and the −X direction can be the front of the vehicle 200.

A Y axis direction is a direction perpendicular to both the X axis direction and the Z axis direction, and indicates a width direction (i.e., a left-right direction) of the vehicle 200. The +Y direction is to the left of the vehicle 200, and the −Y direction is to the right of the vehicle 200. However, when the +X direction is the rear of the vehicle 200, the +Y direction can be the right of the vehicle 200, and the −Y direction can be the left of the vehicle 200. That is, regardless of the X axis direction, the +Y direction simply becomes one side in the right-left direction of the vehicle 200, and the −Y direction becomes the other side in the right-left direction of the vehicle 200. Depending on a method for mounting the drive device 1 on the vehicle 200, the X axis direction can be the width direction (right-left direction) of the vehicle 200, and the Y axis direction can be the front-rear direction of the vehicle 200. In the following preferred embodiment, the Y axis direction is parallel to, for example, a rotation axis J2 of a motor portion 2. The “Y axis direction” in the following description is an example of the “axial direction” of the present invention. Further, the “+Y direction” is an example of the “one axial direction” of the present invention, and the “−Y direction” is an example of the “other axial direction” of the present invention.

Unless otherwise specified in the following description, the direction (Y axis direction) parallel to a predetermined axis such as the rotation axis J2 of the motor portion 2 is sometimes simply referred to as an “axial direction”. Furthermore, a direction orthogonal to a predetermined axis is simply referred to as a “radial direction”, and a circumferential direction about a predetermined axis is referred to as a “circumferential direction”. Of the radial direction, an orientation approaching an axis is referred to as “radially inward”, and an orientation separating from the axis is referred to as “radially outward”. In each component, an end portion radially inward is referred to as a “radially inner end portion”. Furthermore, an end portion outward is referred to as a “radially outer end portion”. Further, in side surfaces of each component, a side surface facing the radially inner side is referred to as a “radially inner surface”, and a side surface facing the radially outer side is referred to as a “radially outer surface”.

In this specification, an “annular shape” includes not only a shape continuously connected without any cut along the entire circumference in the circumferential direction around the central axis but also a shape having one or more cuts in a part of the entire circumference around the central axis. Further, the “annular shape” also includes a shape having a closed curve around the central axis on a curved surface that intersects with the central axis.

In a positional relationship between any one and another of the azimuth, the line, and the surface, “parallel” includes not only a state in which the two endlessly extend without intersecting at all but also a state in which the two are substantially parallel. Further, “orthogonal” and “perpendicular” include not only a state where the two intersect each other at 90 degrees, but also a state where the two are substantially orthogonal and a state where the two are substantially perpendicular. That is, the terms “parallel”, “perpendicular”, and “orthogonal” each include a state in which the positional relationship between both has an angular deviation that does not depart from the gist of the present invention.

Note that these are names used merely for description, and are not intended to limit actual positional relationships, directions, names, and the like.

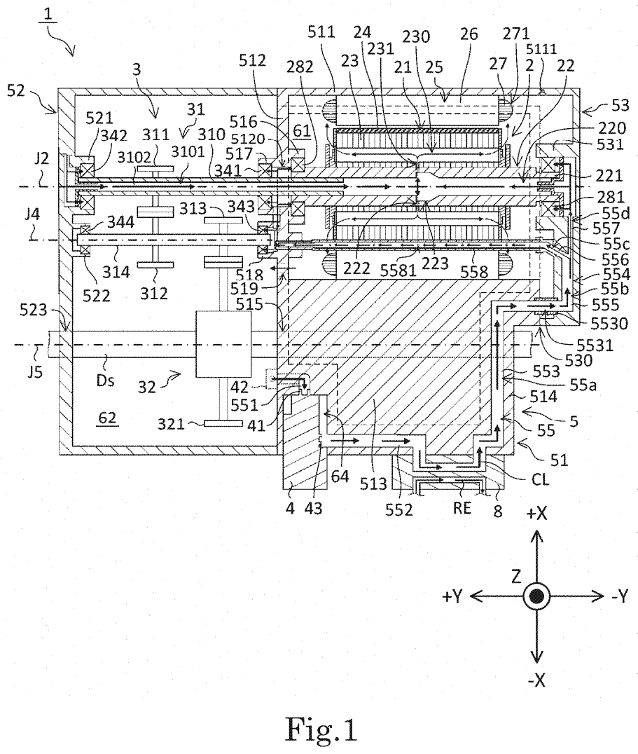

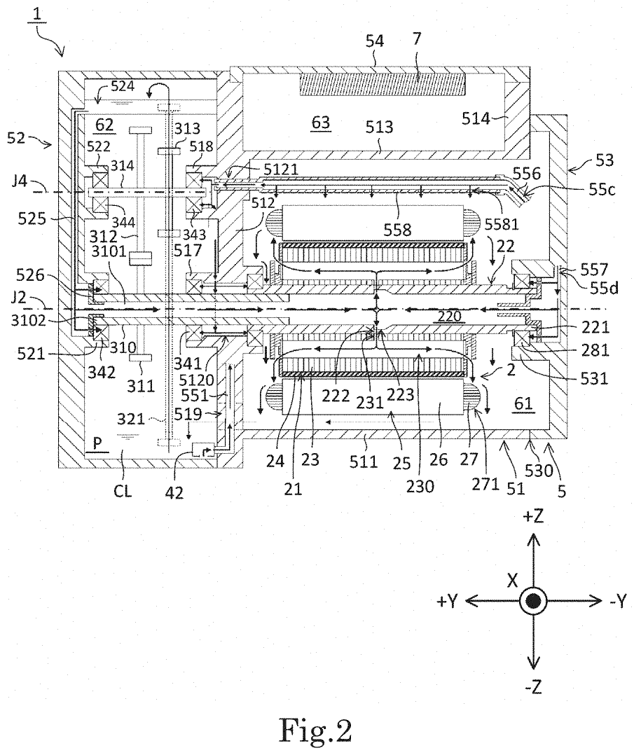

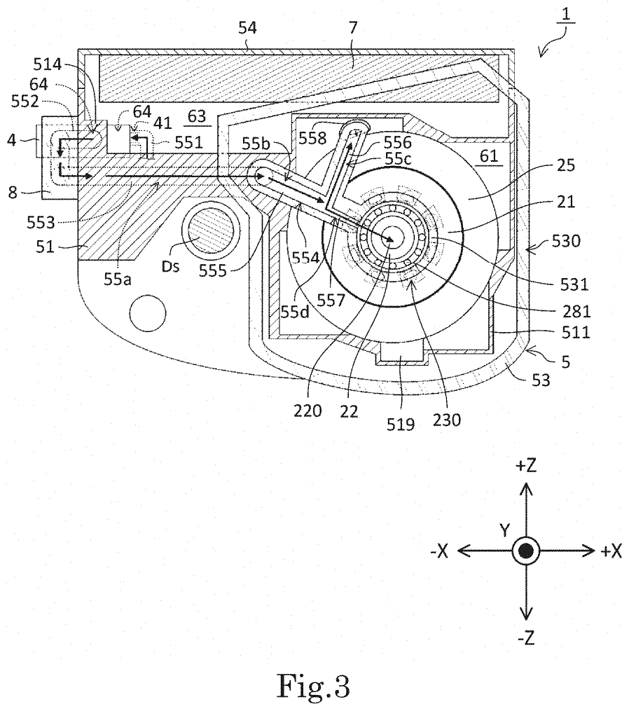

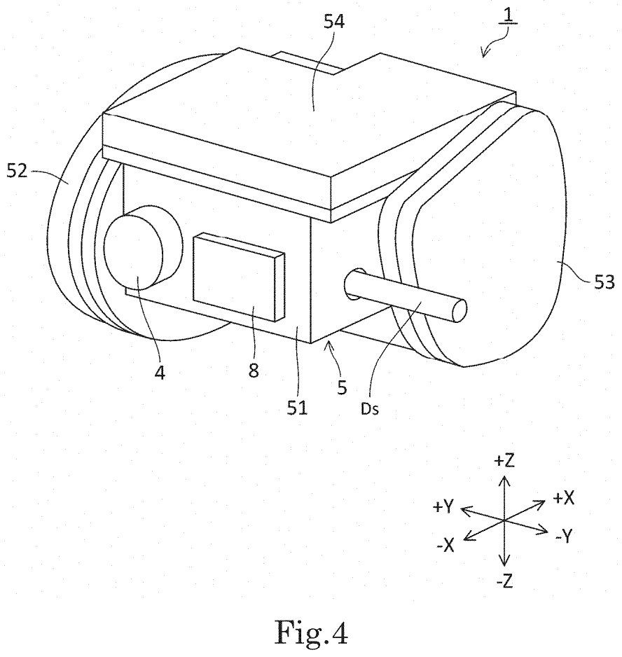

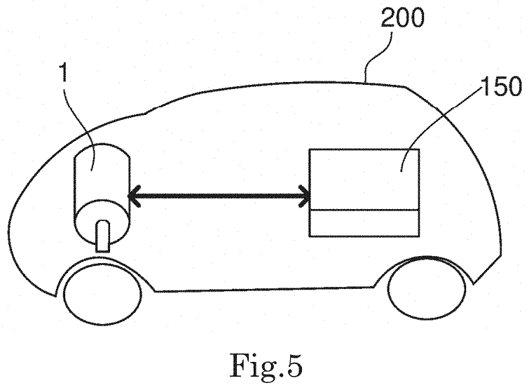

The drive device 1 according to an exemplary preferred embodiment of the present invention will be described below with reference to the drawings. FIGS. 1 to 3 are conceptual views of the drive device 1 according to an preferred embodiment. FIG. 1 is a schematic configuration view of the drive device 1 viewed from the Z axis direction. FIG. 2 is a schematic configuration view of the drive device 1 viewed from the X axis direction. FIG. 3 is a schematic configuration view of the drive device 1 viewed from the Y axis direction. FIG. 4 is a perspective view of the drive device 1. FIG. 5 is a schematic view illustrating an example of a vehicle 200 having the drive device 1. Note that FIGS. 1 to 5 are merely conceptual views, and the layout and dimensions of each portion are not necessarily the same as those of the actual drive device 1.

The drive device 1 is mounted on the vehicle 200 such as a hybrid vehicle (HV), a plug-in hybrid vehicle (PHV), and an electric vehicle (EV) in which at least the motor is used as a power source (see FIG. 5). The drive device 1 is used as the power source of the above-described vehicle 200. The vehicle 200 includes the drive device 1 and a battery 150. The battery 150 stores electric power to be supplied to the drive device 1. In the example of the vehicle 200, the drive device 1 drives the right and left front wheels. The drive device 1 is only required to drive at least any of the wheels.

As illustrated in FIG. 1, the drive device 1 includes the motor portion 2, a gear portion 3, a pump 4, a housing 5, and an oil cooler 8. The motor portion 2 includes a rotor 21 having a motor shaft 22 and a stator 25 located radially outward of the rotor 21. The motor shaft 22 is rotatable about the rotation axis J2 extending along the Y axis direction. The motor shaft 22 is an example of the “shaft” of the present invention, and the Y axis direction is an example of the “axial direction” of the present invention as described above. The gear portion 3 is connected to the end portion of the motor shaft 22 in the +Y direction. The housing 5 accommodates the motor portion 2 and the gear portion 3. The pump 4 supplies an oil CL accommodated in the housing 5 to the motor portion 2. As described above, the drive device 1 includes the pump 4. The oil cooler 8 cools the oil CL. The oil cooler 8 cools the oil CL supplied from the pump 4 to the motor portion 2 in the present preferred embodiment.

The drive device 1 further includes an inverter unit 7. The inverter unit 7 supplies drive electric power to the motor portion 2.

The inside of the housing 5 is provided with an accommodation space that accommodates the motor portion 2, the gear portion 3, the pump 4, and the inverter unit 7. As described later, this accommodation space is partitioned into a motor accommodation portion 61 that accommodates the motor portion 2, a gear accommodation portion 62 that accommodates the gear portion 3, an inverter accommodation portion 63 that accommodates the inverter unit 7, and a pump accommodation portion 64 that accommodates the pump 4. The inverter unit 7 is integrally fixed to a fourth housing member 54 described later.

The motor portion 2 is accommodated in the motor accommodation portion 61 of the housing 5. The motor portion 2 includes the rotor 21 and the stator 25.

When electric power is supplied from a battery (not illustrated) to the stator 25, the rotor 21 rotates about the rotation axis J2 extending in the horizontal direction. The rotor 21 further includes a rotor core 23 and a rotor magnet 24 in addition to the motor shaft 22.

The motor shaft 22 extends along the rotation axis J2. The motor shaft 22 rotates about the rotation axis J2. The motor shaft 22 is rotatably supported by a first motor bearing 281 and a second motor bearing 282. The first motor bearing 281 is, for example, a ball bearing and is held by a third housing member 53 described later in the housing 5. The second motor bearing 282 is, for example, a ball bearing, and is held by a side plate portion 512 described later in the housing 5.

The motor shaft 22 is a tubular hollow shaft. The motor shaft 22 includes a hollow portion 220 and a shaft tubular portion 221 extending in the Y axis direction. The hollow portion 220 is surrounded by the inner side surface of the shaft tubular portion and is connected to a third supply passage 557 (fourth flow path 55d) described later. Specifically, the hollow portion 220 is connected to the third supply passage 557 (fourth flow path 55d) at the end portion of the shaft tubular portion on the −Y direction side. The motor shaft 22 further includes a shaft hole portion 222. The shaft hole portion 222 penetrates the shaft tubular portion 221 in the radial direction.

A hollow transmission shaft 310 of the gear portion 3 described later is inserted and connected to the end portion of the motor shaft 22 on the +Y direction side. In the present preferred embodiment, the both are connected by spline fitting. Alternatively, the both may be joined by a fixing method such as welding. The hollow portion 220 of the motor shaft 22 communicates with a hollow portion 3101 of the transmission shaft 310 described later and a first motor bearing holding portion 531 that accommodates the first motor bearing 281.

The rotor core 23 is a columnar body extending along the Y axis direction. The rotor core 23 is fixed to the radial outside surface of the motor shaft 22. As mentioned earlier, the rotor 21 includes the rotor core 23. A plurality of rotor magnets 24 are fixed to the rotor core 23. The plurality of rotor magnets 24 are aligned along the circumferential direction with the magnetic poles arranged alternately.

The rotor core 23 includes a rotor through hole 230. The rotor through hole 230 penetrates the rotor core 23 in the Y axis direction and is connected to the shaft hole portion 222. The rotor through hole 230 is connected to the third supply passage 557 (fourth flow path 55d) via the hollow portion 220. Specifically, the rotor core 23 includes a rotor communication portion 231. The rotor communication portion 231 is a space penetrating the rotor through hole 230 from the radially inner surface of the rotor core 23, and connects the rotor through hole 230 and the shaft hole portion 222. The rotor through hole 230 is used as a circulation path for the oil CL that cools the rotor 21 from inside. The oil CL circulating through the hollow portion 220 of the motor shaft 22 can flow into the rotor through hole 230 via the shaft hole portion 222 and the rotor communication portion 231 as described later. In this way, when the rotor 21 rotates, the oil CL flows out from the end portion of the rotor through hole 230 in the Y axis direction. This oil CL is supplied to the end portion of the stator 25 in the Y axis direction by centrifugal force due to the rotation of the rotor 21, and is particularly supplied to a coil end 271 described later, which is disposed at the end portion of the stator 25 in the Y axis direction. This oil CL can cool the end portion of the stator 25 in the Y axis direction, especially the coil end 271 of the stator 25.

The stator 25 surrounds the rotor 21 from the outside in the radial direction and rotationally drives the rotor 21. As described above, the stator 25 is disposed radially outward of the rotor 21. That is, the motor portion 2 is an inner rotor motor in which the rotor 21 is disposed inside the stator 25 so as to be rotatable. The stator 25 includes a stator core 26, a coil 27, and an insulator (not illustrated) interposed between the stator core 26 and the coil 27. The stator 25 is held by the housing 5. The stator core 26 includes a plurality of magnetic pole teeth (not illustrated) radially inward from an inner peripheral surface of an annular yoke.

A coil wire is wound between the magnetic pole teeth. The coil wire wound around the magnetic pole teeth constitutes the coil 27. The coil wire is connected to the inverter unit 7 via a bus bar not illustrated. The coil 27 includes a coil end 271 protruding from the axial end surface of the stator core 26. The coil end 271 protrudes in the axial direction relative to the end portion of the rotor core 23 of the rotor 21.

Next, the gear portion 3 transmits the driving force of the motor portion 2 to a drive shaft Ds that drives wheels of the vehicle 200. Details of the gear portion 3 will be described with reference to the drawings. As illustrated in FIG. 1 and the like, the gear portion 3 is accommodated in the gear accommodation portion 62 of the housing 5. The gear portion 3 includes a deceleration device 31 and a differential device 32.

The deceleration device 31 is connected to the motor shaft 22. The deceleration device 31 reduces the rotational speed of the motor portion 2, increases the torque output from the motor portion 2 according to the reduction ratio, and transmits the increased torque to the differential device 32.

The deceleration device 31 includes the transmission shaft 310, a first gear (intermediate drive gear) 311, a second gear (intermediate gear) 312, a third gear (final drive gear) 313, and an intermediate shaft 314. The torque output from the motor portion 2 is transmitted to a fourth gear 321 of the differential device 32 via the motor shaft 22, the transmission shaft 310, the first gear 311, the second gear 312, the intermediate shaft 314, and the third gear 313. The gear ratio of each gear, the number of gears, and the like can be variously changed according to the required reduction ratio. The deceleration device 31 is a parallel axis gear type deceleration device in which the axis centers of the gears are disposed in parallel. The motor shaft 22 and the transmission shaft 310 are spline-fitted.

The transmission shaft 310 extends in the Y axis direction about the rotation axis J2 and rotates about the rotation axis J2 together with the motor shaft 22. The motor shaft 22 is rotatably supported by a first gear bearing 341 and a second gear bearing 342. The first gear bearing 341 is, for example, a ball bearing, and is held by the side plate portion 512 of the housing 5 as described later. The second gear bearing 342 is, for example, a ball bearing, and is held by a second housing member 52 described later.

The transmission shaft 310 is a tubular hollow shaft. The transmission shaft 310 includes a hollow portion 3101 and a transmission shaft tubular portion 3102 of a tubular shape extending in the Y axis direction. The hollow portion 3101 is surrounded by the inner side surface of the transmission shaft tubular portion 3102, and is connected to a gear-side oil passage 525 described later at the end portion of the transmission shaft tubular portion 3102 on the +Y direction side. The −Y direction side end portion of the transmission shaft tubular portion 3102 is connected to the end portion of the motor shaft 22 on the +Y direction side. Further, the end portion of the transmission shaft tubular portion 3102 on the +Y direction side is rotatably held by a second gear bearing holding portion 521 via the second gear bearing 342.

Note that the present invention is not limited to the example of the present preferred embodiment, and the transmission shaft 310 may be the same member as the motor shaft 22, that is, may be integrated. In other words, the motor shaft 22 may be a hollow shaft extending across the motor accommodation portion 61 and the gear accommodation portion 62 of the housing 5. In this case, the +Y direction side end portion of the motor shaft 22 protrudes on the gear accommodation portion 62 side and is rotatably supported by the second gear bearing 342. The hollow portion 220 of the motor shaft 22 communicates with the first motor bearing holding portion 531 that accommodates the first motor bearing 281 and the second gear bearing holding portion 521 that accommodates the second gear bearing 342.

The first gear 311 is provided on the outer circumferential surface of the transmission shaft 310. The first gear 311 may be the same member as or a different member from the transmission shaft 310. When the first gear 311 and the transmission shaft 310 are separate members, the first gear 311 and the transmission shaft 310 are firmly fixed by shrink fitting or the like. The first gear 311 is rotatable about the rotation axis J2 together with the transmission shaft 310.

The intermediate shaft 314 extends along an intermediate axis J4 parallel to the rotation axis J2 and is rotatably supported by the housing 5 about the intermediate axis J4. Both ends of the intermediate shaft 314 are rotatably supported by a third gear bearing 343 and a fourth gear bearing 344. The third gear bearing 343 is, for example, a ball bearing, and is held by the side plate portion 512 of the housing 5. The fourth gear bearing 344 is, for example, a ball bearing, and is held by the second housing member 52.

The second gear 312 and the third gear 313 are provided on the outer circumferential surface of the intermediate shaft 314. The second gear 312 and the third gear 313 may be the same members as or different members from the intermediate shaft 314. When the second gear 312 and the intermediate shaft 314 are separate members, they are firmly fixed by shrink fitting or the like. When the third gear 313 and the intermediate shaft 314 are separate members, they are firmly fixed by shrink fitting or the like. The third gear 313 is disposed closer to the side plate portion 512 than the second gear 312 (i.e., in the −Y direction). The second gear 312 and the third gear 313 are connected to each other with the intermediate shaft 314 interposed therebetween. The second gear 312 and the third gear 313 are rotatable about the intermediate axis J4. The second gear 312 meshes with the first gear 311. The third gear 313 meshes with the fourth gear 321 of the differential device 32.

The torque of the transmission shaft 310 is transmitted from the first gear 311 to the second gear 312. The torque transmitted to the second gear 312 is transmitted to the third gear 313 via the intermediate shaft 314. The torque transmitted to the third gear 313 is transmitted to the fourth gear 321 of the differential device 32. In this manner, the deceleration device 31 transmits, to the differential device 32, the torque output from the motor portion 2.

The differential device 32 is attached to the drive shaft Ds. The differential device 32 transmits the output torque of the motor portion 2 to the drive shaft Ds. The drive shaft Ds is attached to each of the right and left sides of the differential device 32. The differential device 32 has a function of transmitting the same torque to the right and left drive shafts Ds while absorbing a speed difference between the right and left wheels (drive shafts Ds) when the vehicle 200 turns, for example. The differential device 32 includes, for example, a fourth gear (ring gear) 321, a gear housing (not illustrated), a pair of pinion gears (not illustrated), a pinion shaft (not illustrated), and a pair of side gears (not illustrated).

The fourth gear 321 is rotatable about a differential axis J5 parallel to the rotation axis J2. Torque output from the motor portion 2 is transmitted to the fourth gear 321 via the deceleration device 31. Further, the portion of the fourth gear 321 on the −Z direction side is immersed in the lower oil pool P in the gear accommodation portion 62. For example, the oil CL is scraped up by the tooth surface of the fourth gear 321 when the fourth gear 321 of the differential device 32 rotates. A part of the oil is supplied to the inside of the gear accommodation portion 62 and is used for lubricating the gears and bearings of the speed deceleration device 31 and the differential device 32 in the gear accommodation portion 62. Further, the other part of the scraped-up oil CL is stored in a saucer portion 524 described later, and then supplied to the hollow portion 220 of the motor shaft 22 through the hollow portion 3101 of the gear-side oil passage 525 and the transmission shaft 310 described later so as to be used to cool the stator 25.

Next, the pump 4 is an electric pump driven by electricity, and is connected to the inverter unit 7 via a harness cable (not illustrated). That is, the pump 4 is driven by the inverter unit 7. As the pump 4, a trochoidal pump, a centrifugal pump, or the like can be employed. The pump 4 is provided in the pump accommodation portion 64 formed in the housing 5. For example, the pump 4 is fixed to the housing 5 with a bolt (not illustrated).

A suction port 41 of the pump 4 is inserted into a first oil passage 551 so as to close the first oil passage 551 described later. The suction port 41 of the pump 4 is connected to a strainer 42 via the first oil passage 551 described later. The strainer 42 is disposed in the gear accommodation portion 62 of the housing 5. The strainer 42 is disposed in the oil pool P (see FIG. 2 and the like) of the gear accommodation portion 62 described later. The strainer 42 sucks the oil CL by drive of the pump 4 from an inlet (not illustrated) disposed on the lower surface thereof and supplies the oil CL to the suction port 41 of the pump 4. A filtration structure (not illustrated) such as a filter is attached to the strainer 42. By attaching the filtration structure, it is possible to suppress mixing of foreign matters into the pump 4 and mixing of foreign matters into the motor portion 2.

A discharge port 43 of the pump 4 opens to the pump accommodation portion 64. That is, the oil CL protruding from the pump 4 fills the pump accommodation portion 64. A second oil passage 552 described later is connected to the pump accommodation portion 64. The pump 4 discharges the oil CL sucked from the suction port 41 from the discharge port 43 and sends the oil CL to the oil cooler 8 via the second oil passage 552.

The oil cooler 8 performs heat exchange between the oil CL sent from the pump 4 via the second oil passage 552 and a refrigerant RE supplied in a system different from a motor-side oil passage 55 described later including the second oil passage 552. Thus, the oil cooler 8 cools the oil CL to be sent from the pump 4. The oil CL cooled by the oil cooler 8 is supplied to the motor portion 2 via a third oil passage 553 and a fourth oil passage 554 described later. The refrigerant RE is supplied to the oil cooler 8 after cooling an IGBT, an SIC element, and the like (not illustrated) of the inverter unit 7.

The pump accommodation portion 64 is formed in a peripheral wall portion 514 surrounding the inverter accommodation portion 63 (see FIG. 3). For example, the pump accommodation portion 64 can be disposed using a dead space other than the space occupied by the inverter unit 7 in the inverter accommodation portion 63. This allows the pump 4 to be compactly disposed, which can contribute to downsizing of the drive device 1.

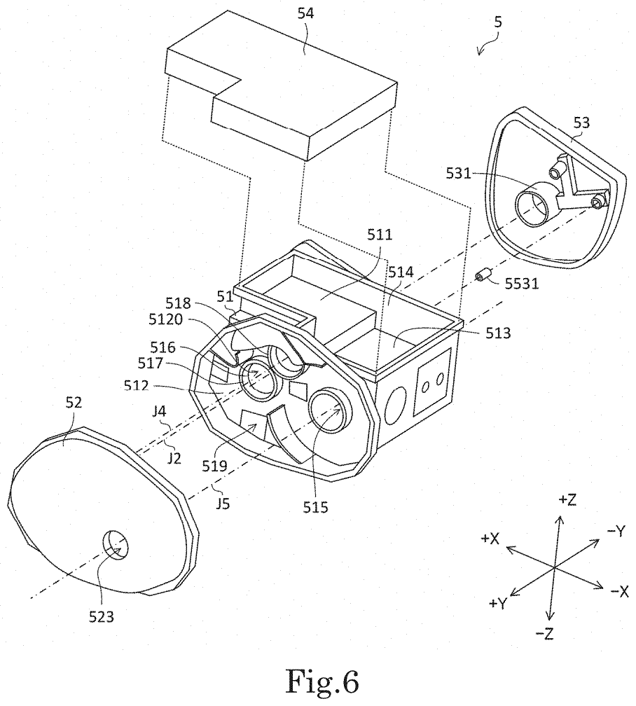

Next, the configuration of the housing 5 will be described. FIG. 6 is an exploded view of the housing 5. As illustrated in FIG. 6, the housing 5 includes a first housing member 51. The first housing member 51 includes a tubular portion 511 of a tubular shape. That is, the housing 5 includes the tubular portion 511. The tubular portion 511 extends in the Y axis direction and surrounds the stator 25. The tubular portion 511 is an example of the “first housing” of the present invention. Further, the first housing member 51 further includes a side plate portion 512. That is, the housing 5 includes the side plate portion 512. The side plate portion 512 covers the end portion of the tubular portion 511 on the +Y direction side. The end portion on the +Y direction side corresponds to the “other axial end portion”. In the present preferred embodiment, the tubular portion 511 and the side plate portion 512 are the identical member. However, the present invention is not limited to this example, and the tubular portion 511 and the side plate portion 512 may be different members.

The housing 5 further includes the second housing member 52. The second housing member 52 is attached to the end portion of the side plate portion 512 on the +Y direction side. The second housing member 52 and the side plate portion 512 constitute the gear accommodation portion 62 which will be described later.

The housing 5 further includes the third housing member 53. The third housing member 53 is an example of the “second housing” of the present invention. The third housing member 53 is attached to the end portion of the tubular portion 511 on the −Y direction side. The end portion on the −Y direction side corresponds to the “one axial end portion” of the present invention. The third housing member 53 closes and shuts the end portion of the tubular portion 511 on the −Y direction side.

As illustrated in FIG. 3, a contact portion 530 in which the third housing member 53 contacts the tubular portion 511 is annular when viewed from the Y axis direction. The housing 5 includes a continuous contact portion 530 in which the tubular portion 511 and the third housing member 53 are in contact with each other. The third housing member 53 has the first motor bearing 281 that rotatably supports the motor shaft 22. Note that the first motor bearing 281 is an example of a “bearing” of the present invention. Further, the third housing member 53 has the first motor bearing holding portion 531 that holds the first motor bearing 281. The first motor bearing holding portion 531 rotatably supports the end portion of the motor shaft 22 on the −Y direction side via the first motor bearing 281.

The housing 5 further includes the fourth housing member 54. The fourth housing member 54 is disposed vertically above the tubular portion 511. The vertically upward direction is perpendicular to the axial direction. The fourth housing member 54 is attached to an upper portion of the first housing member 51.

Further, the housing 5 further includes the motor accommodation portion 61. The motor accommodation portion 61 is surrounded by the tubular portion 511 and the third housing member 53, and accommodates the motor portion 2. The motor accommodation portion 61 is an example of the “motor accommodation space” of the present invention. Specifically, the motor accommodation portion 61 is a space surrounded by the tubular portion 511, the side plate portion 512, and the third housing member 53, and accommodates the motor portion 2.

Further, the housing 5 further includes the gear accommodation portion 62. The gear accommodation portion 62 is a space surrounded by the side plate portion 512 and the second housing member 52, and accommodates the gear portion 3. At the lower part of the gear accommodation portion 62 in the vertical direction, there is the oil pool P in which the oil CL is accumulated. The motor accommodation portion 61 and the gear accommodation portion 62 are partitioned by the side plate portion 512.

The housing 5 further includes the inverter accommodation portion 63 that accommodates the inverter unit 7. The inverter accommodation portion 63 is a space surrounded by the tubular portion 511, a plate portion 513 described later, and the peripheral wall portion 514 described later. The inverter accommodation portion 63 opens in the +Z direction. The opening is covered with the fourth housing member 54. The inverter unit 7 is integrally fixed to the fourth housing member 54. That is, the inverter unit 7 is fixed downward to the inverter accommodation portion 63 by integrally fixing the inverter unit 7 to the lower side of the fourth housing member 54. The fourth housing member 54 may be provided with an inverter cooling path (not illustrated).

Further, the housing 5 includes the pump accommodation portion 64. The pump accommodation portion 64 accommodates the pump 4. The pump accommodation portion 64 is formed in the first housing member 51. That is, the first housing member 51 further includes the pump accommodation portion 64.

Next, the first housing member 51 further includes the plate portion 513 and the peripheral wall portion 514. That is, the housing 5 includes the plate portion 513 and the peripheral wall portion 514. The plate portion 513 expands from the tubular portion 511 in the X axis direction perpendicular to the Y axis direction. The peripheral wall portion 514 surrounds the inverter accommodation portion 63 when viewed from the Y axis direction and the Z axis direction perpendicular to the X axis direction. Specifically, the plate portion 513 extends in the −X direction from the outer surface of the tubular portion 511. The peripheral wall portion 514 protrudes in the +Z direction from the upper end portion of the tubular portion 511 and the plate portion 513, and surrounds the inverter accommodation portion 63 when viewed from the vertical direction (see FIG. 1).

The first housing member 51 further includes an insertion hole 5120, a first drive shaft passage hole 515, a second motor bearing holding portion 516, a first gear bearing holding portion 517, a third gear bearing holding portion 518, and a side plate opening 519.

The insertion hole 5120 and the first drive shaft passage hole 515 are disposed in the side plate portion 512 and penetrate the side plate portion 512 in the Y axis direction. The center of the insertion hole 5120 coincides with the rotation axis J2. The second motor bearing holding portion 516 is disposed on the −Y direction side of the insertion hole 5120. The first gear bearing holding portion 517 is disposed on the +Y direction side of the insertion hole 5120.

The drive shaft Ds penetrates through the first drive shaft passage hole 515 in a rotatable state. A second drive shaft passage hole 523 is disposed in the second housing member 52. The second drive shaft passage hole 523 is a hole penetrating the second housing member 52 in the axial direction. The drive shaft Ds rotatably penetrates the second drive shaft passage hole 523. The second drive shaft passage hole 523 overlaps the first drive shaft passage hole 515 when viewed from the axial direction. Consequently, the drive shaft Ds disposed at both ends in the Y axis direction of the differential device 32 rotates about the differential axis J5. An oil seal (not illustrated) is provided between the drive shaft Ds and the first drive shaft passage hole 515 and between the drive shaft Ds and the second drive shaft passage hole 523 in order to suppress leakage of the oil CL. An axle (not illustrated) that rotates the wheel is connected to a front end of the drive shaft Ds.

The second motor bearing holding portion 516 extends in the −Y direction from the edge portion of the insertion hole 5120. An outer ring of the second motor bearing 282 is fixed to the second motor bearing holding portion 516. The +Y direction side end portion of the motor shaft 22 is fixed to the inner ring of the second motor bearing 282. The first motor bearing holding portion 531 is disposed on the +Y direction side of the third housing member 53. The central axes of the first motor bearing holding portion 531 and the second motor bearing holding portion 516 each coincide with the rotation axis J2. An outer ring of the first motor bearing 281 is fixed to the first motor bearing holding portion 531. The −Y direction side end portion of the motor shaft 22 is fixed to the inner ring of the first motor bearing 281. As a result, both ends of the rotor 21 in the Y axis direction of the motor portion 2 are rotatably supported by the housing 5 via the first motor bearing 281 and the second motor bearing 282.

The first gear bearing holding portion 517 extends in the +Y direction from the edge portion of the insertion hole 5120. An outer ring of the first gear bearing 341 is fixed to the first gear bearing holding portion 517. The −Y direction side end portion of the transmission shaft 310 is fixed to the inner ring of the first gear bearing 341. The second gear bearing holding portion 521 is disposed on the −Y direction side of the second housing member 52. The central axes of the second gear bearing holding portion 521 and the first gear bearing holding portion 517 coincide with the rotation axis J2. An outer ring of the second gear bearing 342 is fixed to the second gear bearing holding portion 521. The transmission shaft 310 is fixed to the inner ring of the second gear bearing 342. As a result, the transmission shaft 310 is rotatably supported by the side plate portion 512 of the housing 5 and the second housing member 52 via the first gear bearing 341 and the second gear bearing 342.

Next, the third gear bearing holding portion 518 has a tubular shape extending in the +Y direction from the side plate portion 512. The third gear bearing holding portion 518 is disposed in the −X direction and the +Z direction with respect to the first gear bearing holding portion 517. An outer ring of the third gear bearing 343 is fixed to the third gear bearing holding portion 518. The intermediate shaft 314 is fixed to the inner ring of the third gear bearing 343. A fourth gear bearing holding portion 522 is disposed on the −Y direction side of the second housing member 52. The fourth gear bearing holding portion 522 has a tubular shape extending in the −Y direction from the second housing member 52. The central axes of the third gear bearing holding portion 518 and the fourth gear bearing holding portion 522 coincide with the intermediate axis J4. An outer ring of the fourth gear bearing 344 is fixed to the fourth gear bearing holding portion 522. The +Y direction side end portion of the intermediate shaft 314 is fixed to the inner ring of the fourth gear bearing 344. As a result, the intermediate shaft 314 is rotatably supported by the side plate portion 512 of the housing 5 and the second housing member 52 via the third gear bearing 343 and the fourth gear bearing 344.

The side plate opening 519 is provided in the side plate portion 512 that partitions the motor accommodation portion 61 and the gear accommodation portion 62. The housing 5 includes the side plate opening 519. The side plate opening 519 penetrates the side plate portion 512 in the axial direction and connects the motor accommodation portion 61 and the gear accommodation portion 62. The side plate opening 519 causes in particular the lower portion of the motor accommodation portion 61 and the lower portion of the gear accommodation portion 62 to communicate with each other. The side plate opening 519 allows the oil CL accumulated in the lower portion in the motor accommodation portion 61 to move to the gear accommodation portion 62. The oil CL having moved to the gear accommodation portion 62 can flow into the oil pool P.

Next, the configuration of the second housing member 52 will be described. The second housing member 52 is attached to the +Y direction side of side plate portion 512 of the first housing member 51. The second housing member 52 has a recessed shape that is open to the side plate portion 512 side. The opening of the second housing member 52 is covered with the side plate portion 512. As illustrated in FIG. 1 and the like, the second housing member 52 includes the second gear bearing holding portion 521, the fourth gear bearing holding portion 522, and the second drive shaft passage hole 523. Since these descriptions have been made previously, they are omitted here.

The second housing member 52 includes a saucer portion 524, a gear-side oil passage 525, and a gear-side restricting member 526. In other words, the housing 5 includes the saucer portion 524, the gear-side oil passage 525, and the gear-side restricting member 526.

The saucer portion 524 is disposed radially outward with respect to the fourth gear 321 based on the differential axis J5 and opens in the +Z direction (that is, vertically upward). The oil CL scraped up by the fourth gear 321 is stored in the saucer portion 524. The saucer portion 524 extends in the +Y direction from the side plate portion 512. The end portion of the saucer portion 524 on the +Y direction side is connected to the inner surface of the second housing member 52 facing the −Y direction.

The gear-side oil passage 525 is formed inside the second housing member 52. The gear-side oil passage 525 is the passage of the oil CL for connecting the end portion of the saucer portion 524 on the +Y direction side and the second gear bearing holding portion 521. Further, one end of the gear-side oil passage 525 is connected to the end portion of the saucer portion 524 on the +Y direction side and is connected to the saucer portion 524. The other end of the gear-side oil passage 525 is connected to the second gear bearing holding portion 521. The oil CL stored in the saucer portion 524 is supplied to the gear-side oil passage 525. As illustrated in FIG. 2, a part of the oil CL supplied to the gear-side oil passage 525 is supplied to the second gear bearing 342. Further, the other part of the oil CL supplied to the gear-side oil passage 525 flows into the hollow portion 3101 from the end portion of the transmission shaft 310 on the +Y direction side and flows in the −Y direction, and flows into the hollow portion 220 of the motor shaft 22.

The gear-side restricting member 526 restricts the amount of the oil CL supplied from the gear-side oil passage 525 to the second gear bearing 342. Due to this restriction, the oil CL supplied from the gear-side oil passage 525 to the hollow portion 220 of the motor shaft 22 through the hollow portion 3101 of the transmission shaft 310 can be secured. The gear-side restricting member 526 includes an annular portion (reference numeral omitted) facing the second gear bearing 342 in the Y axis direction and a tubular portion (reference numeral omitted) which extends in the −Y direction from the radially inner end portion of the annular portion and is inserted into the transmission shaft 310. The annular portion includes a through hole (reference numeral omitted) that penetrates the annular portion in the Y axis direction. The oil CL is supplied to the second gear bearing 342 through the through hole and is supplied into the transmission shaft 310 through the tubular portion.

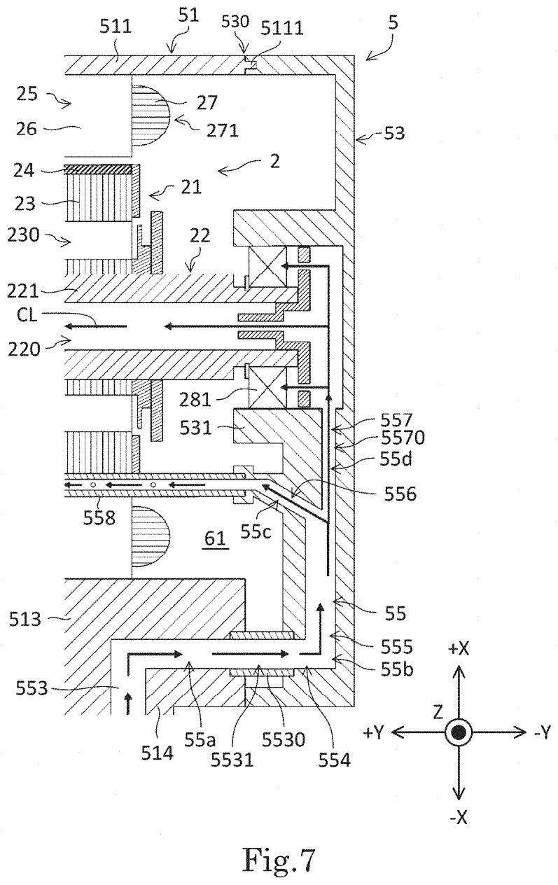

Next, the motor-side oil passage 55 will be described with reference to FIGS. 1 to 3 and FIG. 7. FIG. 7 is a schematic view illustrating a configuration example of the motor-side oil passage 55. Note that FIG. 7 is viewed from the +Z direction to the −Z direction.

Next, for example, as illustrated in FIGS. 1 to 3, the housing 5 further includes the motor-side oil passage 55 through which the oil CL flows. The motor-side oil passage 55 is an example of the “refrigerant flow path” of the present invention. Further, the oil CL is a lubricating liquid and is an example of the “refrigerant” of the present invention. A part of the motor-side oil passage 55 is disposed in the first housing member 51, and the rest part is disposed in the third housing member 53. The motor-side oil passage 55 is a flow path through which the oil CL sucked up from the oil pool P of the gear accommodation portion 62 by the pump 4 and cooled by the oil cooler 8 flows toward the motor portion 2.

The motor-side oil passage 55 includes the first oil passage 551, the second oil passage 552, the third oil passage 553, and the fourth oil passage 554. The first oil passage 551, the second oil passage 552, and the third oil passage 553 are formed in the first housing member 51.

As described above, the first oil passage 551 connects the gear accommodation portion 62 and the suction port 41 of the pump 4, and particularly connects the vertically lower portion of the gear accommodation portion 62 and the suction port 41 of the pump 4. In the present preferred embodiment, the first oil passage 551 is formed inside the side plate portion 512.

The second oil passage 552 connects the discharge port 43 of the pump 4 and the oil cooler 8, and supplies the oil CL discharged from the pump 4 to the oil cooler 8. The third oil passage 553 is connected to the fourth oil passage 554 via a connection flow path 5531 described later. The second oil passage 552 and the third oil passage 553 constitute a first flow path 55a. The motor-side oil passage 55 includes the first flow path 55a through which the oil CL sent from the pump 4 flows. The first flow path 55a is disposed in the first housing member 51.

The second oil passage 552 and the third oil passage 553 (first flow path 55a) are disposed in either the plate portion 513 or the peripheral wall portion 514. For example, in the preferred embodiment, the second oil passage 552 and the third oil passage 553 (first flow path 55a) are formed inside the peripheral wall portion 514. However, the present invention is not limited to this example, and at least one of the second oil passage 552 and the third oil passage 553 may be formed inside the plate portion 513. In this way, for example, the second oil passage 552 and the third oil passage 553 (first flow path 55a) can be disposed by using the dead space other than the space occupied by the inverter unit 7 in the inverter accommodation portion 63. Therefore, since the motor-side oil passage 55 can be disposed compactly, it can contribute to the miniaturization of the drive device 1.

The fourth oil passage 554 connects the third oil passage 553 and the motor accommodation portion 61. The fourth oil passage 554 is disposed in the third housing member 53. In other words, the fourth oil passage 554 is a through hole formed in the third housing member 53. In this way, the fourth oil passage 554 can be disposed without increasing the number of parts of the drive device 1.

Further, the motor-side oil passage 55 further includes the connection flow path 5531. The connection flow path 5531 connects the second oil passage 552 and the third oil passage 553 (first flow path 55a) and the fourth oil passage 554 (second flow path 55b described later). Specifically, the end portion of the connection flow path 5531 on the +Y direction side is connected to the end portion of the third oil passage 553 (first flow path 55a) on the −Y direction side. The end portion of the connection flow path 5531 on the −Y direction side is connected to the end portion of the fourth oil passage 554 (second flow path 55b) on the +Y direction side. At least a part of the connection flow path 5531 is disposed in the motor accommodation portion 61. Thus, even if the oil CL leaks at the connection portion between at least one of the third oil passage 553 (first flow path 55a) and the fourth oil passage 554 (second flow path 55b) and the connection flow path 5531, the leaked oil CL flows down into the motor accommodation portion 61. Therefore, since it is not necessary to strictly seal the above-described connection portion, the third oil passage 553 (first flow path 55a) can be connected to the fourth oil passage 554 (second flow path 55b) with a simple configuration. Thus, the flow paths of the oil CL can be connected to each other without needing of strict sealing. The leakage of the oil Cl at the connection portion described above is likely to occur according to the height of the internal pressure of the motor-side oil passage 55. Therefore, when the internal pressure of the motor-side oil passage 55 becomes excessively high, the internal pressure can be reduced by leakage of the oil CL at the connection portion described above, so that the life of the motor-side oil passage 55 can be extended.

Further, when viewed from the axial direction, the connection flow path 5531 is disposed inside the contact portion 530 between the first housing member 51 and the third housing member 53 (see, for example, FIG. 3). In this way, a part of the connection flow path 5531 can be reliably disposed in the motor accommodation portion 61.

In the present preferred embodiment, the end portion of the third oil passage 553 (first flow path 55a) and the end portion of the fourth oil passage 554 (second flow path 55b) connected by the connection flow path 5531 face each other with a gap therebetween. In this way, the connection flow path 5531 can be configured in a simple manner.

The connection flow path 5531 is a space surrounded by the inner side surface of a connection pipe 5530. The housing 5 includes a tubular connection pipe 5530 that connects the first oil passage 551, the second oil passage 552, the third oil passage 553 (first flow path 55a), and a first supply passage 555 (second flow path 55b) described later of the fourth oil passage 554. The connection pipe 5530 is an example of the “connection member” of the present invention. The connection pipe 5530 extends in the Y axis direction. In the present preferred embodiment, the connection pipe 5530 is a member separated from the first housing member 51 and the third housing member 53. The one end portion of the connection pipe 5530 is connected to the third oil passage 553 (first flow path 55a). The other end portion of the connection pipe 5530 is connected to the first supply passage 555 (second flow path 55b) of the fourth oil passage 554. Thus, the positioning between the end portions of the third oil passage 553 (first flow path 55a) and the fourth oil passage 554 (second flow path 55b) can be made easy by the connection pipe 5530. When the third oil passage 553 (first flow path 55a) is disposed in the first housing member 51 and the fourth oil passage 554 (second flow path 55b) is disposed in the third housing member 53, the third housing member 53 can be positioned with respect to the first housing member 51 by the connection pipe 5530. Therefore, the third housing member 53 can be easily attached to the first housing member 51, and for example, the number of positioning pins 5111 for performing the above-described positioning can be reduced.

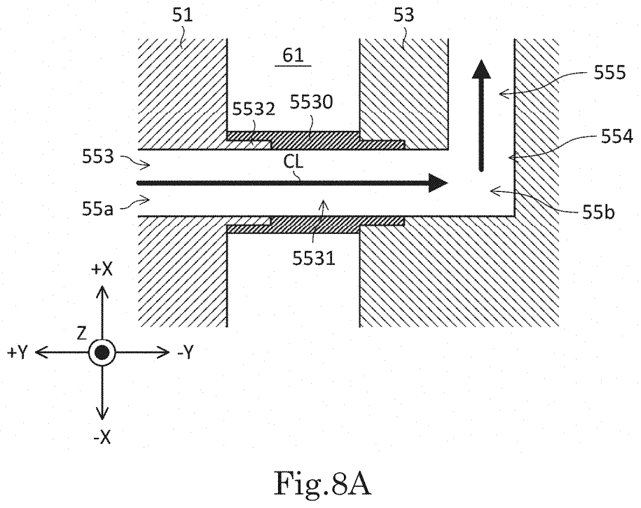

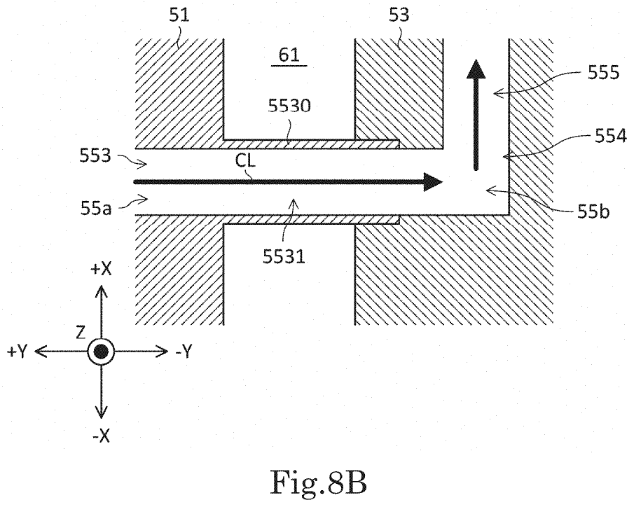

Specifically, the end portion of the connection pipe 5530 on the +Y direction side is fitted to the end portion of the third oil passage 553 (first flow path 55a) on the −Y direction side. The end portion of the connection pipe 5530 on the −Y direction side is fitted to the end portion of the fourth oil passage 554 (second flow path 55b) on the +Y direction side. However, the shape of the connection pipe 5530 is not limited to this example. FIG. 8A is a first preferred modification of the connection pipe 5530. FIG. 8B is a second preferred modification of the connection pipe 5530.

For example, as illustrated in FIG. 8A, the first housing member 51 may have a tubular portion 5532 extending in the −Y direction from a portion along the outer edge of the end portion (that is, the opening facing the motor accommodation portion 61) on the −Y direction side of the third oil passage 553 (first flow path 55a). The tubular portion 5532 may be fitted into the end portion of the connection pipe 5530 on the +Y direction side. In addition or alternatively, the third housing member 53 may have a tubular portion extending in the +Y direction from a portion along the outer edge of the end portion (that is, the opening facing the motor accommodation portion 61) of the fourth oil passage 554 (second flow path 55b) on the +Y direction side, and the tubular portion may be fitted into the end portion of the connection pipe 5530 on the −Y direction side.

Alternatively, as illustrated in FIG. 8B, the connection pipe 5530 may be integrated with one of the first housing member 51 and the third housing member 53, or may be a member different from the other. In this case, the connection flow path 5531 is integrated with one of the third oil passage 553 (first flow path 55a) and the fourth oil passage 554 (second flow path 55b), and is connected to the other of the third oil passage 553 (first flow path 55a) and the fourth oil passage 554 (second flow path 55b). Thus, the positioning between the end portion of the third oil passage 553 (first flow path 55a) and the end portion of the fourth oil passage 554 (second flow path 55b) can be made easy by the connection pipe 5530. When the second oil passage 552 and the third oil passage 553 (first flow path 55a) are disposed in the first housing member 51 and the fourth oil passage 554 (second flow path 55b) is disposed in the third housing member 53, the third housing member 53 can be positioned with respect to the first housing member 51 by the connection pipe 5530. Therefore, the third housing member 53 can be easily attached to the first housing member 51, and for example, the number of positioning pins 5111 for performing the above-described positioning can be reduced.

For example, the connection pipe 5530 may be a tubular member extending in the −Y direction from a portion along the outer edge of the end portion (that is, the opening facing the motor accommodation portion 61) on the −Y direction side of the third oil passage 553 (first flow path 55a) of the first housing member 51. Alternatively, the connection pipe 5530 may be a tubular member extending in the +Y direction from a portion along the outer edge of the end portion (that is, the opening facing the motor accommodation portion 61) on the +Y direction side of the fourth oil passage 554 (second flow path 55b) of the third housing member 53.

The fourth oil passage 554 includes a first supply passage 555, a second supply passage 556, and a third supply passage 557. The first supply passage 555 is connected to the third oil passage 553 via the connection flow path 5531. The second supply passage 556 connects the first supply passage 555 and an oil supply portion 558. The third supply passage 557 connects the first supply passage 555 and the hollow portion 220 of the motor shaft 22. That is, one end portion of the fourth oil passage 554 is the first supply passage 555, and the other end portion of the fourth oil passage 554 branches into the second supply passage 556 and the third supply passage 557.

In other words, the motor-side oil passage 55 includes the first supply passage 555. The first supply passage 555 constitutes the second flow path 55b. The motor-side oil passage 55 includes the second flow path 55b disposed in the third housing member 53. The oil CL supplied to the motor portion 2 flows through the first supply passage 555 (second flow path 55b).

Further, the motor-side oil passage 55 further includes the second supply passage 556 and the third supply passage 557. The second supply passage 556 constitutes the third flow path 55c, and the third supply passage 557 constitutes the fourth flowpath 55d. The motor-side oil passage 55 includes the third flow path 55c and the fourth flow path 55d. The second supply passage 556 (third flow path 55c) supplies a part of the oil CL flowing through the first supply passage 555 (second flow path 55b) to the outer surface of the stator 25. The third supply passage 557 (fourth flow path 55d) supplies another part of the oil CL flowing through the first supply passage 555 (second flow path 55b) to the first motor bearing 281. Thus, the outer surface of the stator 25 can be cooled by a part of the oil CL delivered from the pump 4, and the first motor bearing 281 that rotatably supports the motor shaft 22 can be lubricated by the other part.

Further, the second supply passage 556 (third flow path 55c) and the third supply passage 557 (fourth flow path 55d) extend in a direction intersecting the Y axis direction. In this way, it is possible to suppress an increase in the size of the third housing member 53 in the Y axis direction due to the arrangement of the second supply passage 556 (third flow path 55c) and the third supply passage 557 (fourth flow path 55d).

Preferably, the inner diameter of the second supply passage 556 (third flow path 55c) may be larger than the inner diameter of the third supply passage 557 (fourth flow path 55d). Specifically, the minimum flow-path cross-sectional area in the second supply passage 556 (third flow path 55c) may be wider than the minimum flow-path cross-sectional area in the third supply passage 557 (fourth flow path 55d). In this way, the oil CL flowing through the first supply passage 555 (second flow path 55b) flows more easily to the second supply passage 556 (third flow path 55c) than to the third supply passage 557 (fourth flow path 55d). Therefore, even if the pressure of the oil CL flowing through the motor-side oil passage 55 is not increased so much, a sufficient amount of the oil CL flows through the third supply passage 557 (fourth flow path 55d) so that the oil can be supplied to the outer surface of the stator 25. Note that the above examples do not exclude a configuration in which the minimum flow-path cross-sectional area in the second supply passage 556 (third flow path 55c) is smaller than the minimum flow-path cross-sectional area in the third supply passage 557 (fourth flow path 55d), and a configuration in which both are equal.

Next, the second supply passage 556 (third flow path 55c) is connected to the oil supply portion 558. The oil supply portion 558 is accommodated in the motor accommodation portion 61 together with the motor portion 2. The oil supply portion 558 is an example of the “refrigerant supply portion” of the present invention. The drive device 1 further includes the oil supply portion 558. Specifically, the oil supply portion 558 is a tubular member extending in the Y axis direction, and is disposed radially outward from the stator 25 and vertically above the rotation axis J2 (that is, in the +Z direction). The inside of the oil supply portion 558 is connected to the second supply passage 556 (third flow path 55c). Further, the inside of the oil supply portion 558 is connected to the third gear bearing holding portion 518 via a hole 5121 that penetrates the side plate portion 512 in the Y axis direction.

The oil supply portion 558 includes a spray hole 5581. The spray hole 5581 is an example of the “refrigerant supply hole” of the present invention. The spray hole 5581 penetrates from the inner side surface of the oil supply portion 558 to the outer surface and opens toward the outer surface of the stator 25. In this way, the oil supply portion 558 can spray the oil CL flowing through the third supply passage 557 (fourth flow path 55d) from the spray hole 5581 toward the outer surface of the stator 25, and the stator 25 can be cooled from the radially outer surface.

In addition, the third supply passage 557 (fourth flow path 55d) is connected to the hollow portion 220 of the motor shaft 22 via the first motor bearing holding portion 531. As described above, the hollow portion 220 of the motor shaft 22 is connected to the rotor through hole 230 of the rotor core 23. For example, the hollow portion 220 of the motor shaft 22 is connected to the rotor through hole 230 via the recess 223, the shaft hole portion 222, and the rotor communication portion 231. That is, the rotor through hole 230 is connected to the third supply passage 557 (fourth flow path 55d) via the first motor bearing holding portion 531 and the hollow portion 220. Therefore, when the rotor 21 rotates, the oil CL is supplied from the end portion of the rotor through hole 230 in the Y axis direction to the end portion of the stator 25 in the Y axis direction. Thus, the end portion of the stator 25 in the Y axis direction can be cooled by the oil CL supplied from the rotor through hole 230, and in particular, the coil end 271 of the stator 25 can be cooled.

The oil CL having cooled the motor portion 2 accumulates in the lower portion of the motor accommodation portion 61 and then flows to the oil pool P in the lower portion of the gear accommodation portion 62 through the side plate opening 519. That is, the oil CL supplied from the second supply passage 556 (third flow path 55c) to the radial outside surface of the stator 25 via the oil supply portion 558 and having cooled the stator 25 accumulates in the lower portion of the motor accommodation portion 61, and then flows to the oil pool P in the lower portion of the gear accommodation portion 62 through the side plate opening 519. The oil CL supplied from the third supply passage 557 (fourth flow path 55d) to the coil end 271 and the like via the rotor through hole 230 accumulates in the lower portion of the motor accommodation portion 61, and then flows to the oil pool P in the lower portion of the gear accommodation portion 62 through the side plate opening 519.

The preferred embodiment of the present invention has been described above. Note that, the scope of the present invention is not limited to the above-described preferred embodiment. The present invention can be implemented by making various modifications to the above-described preferred embodiment without departing from the gist of the invention. In addition, the matters described in the above-described preferred embodiment can be discretionarily combined as appropriate within a range where no inconsistency occurs.

The present invention is useful for a drive motor for a vehicle such as a hybrid vehicle (HV), a plug-in hybrid vehicle (PHV), and an electric vehicle (EV).

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive device comprising:
a motor portion; and
a housing that accommodates the motor portion,
wherein the motor portion includes:
a rotor having a shaft that is rotatable about a rotation axis extending along an axial direction; and
a stator disposed radially outward of the rotor,
the housing includes:
a first housing extending in the axial direction and surrounding the stator;
a second housing attached to an one axial end portion of the first housing;
a motor accommodation space surrounded by the first housing and the second housing to accommodate the motor portion; and
a refrigerant flow path through which a refrigerant flows,
the refrigerant flow path includes:
a first flow path which is disposed in the first housing and through which the refrigerant sent from a pump flows;
a second flow path which is disposed in the second housing and through which the refrigerant to be supplied to the motor portion flows; and
a connection flow path for connecting the first flow path and the second flow path, and
at least a part of the connection flow path is disposed in the motor accommodation space.

2. The drive device according to claim 1, wherein
the housing includes a contact portion at which the first housing and the second housing are in contact with each other, and
the connection flow path is disposed inside the contact portion when viewed from the axial direction.

3. The drive device according to claim 1, wherein
the second housing includes a bearing that rotatably supports the shaft,
the refrigerant is a lubricating liquid, and
the refrigerant flow path includes:
a third flow path for supplying a part of the refrigerant flowing through the second flow path to an outer surface of the stator; and
a fourth flow path for supplying another part of the refrigerant flowing through the second flow path to the bearing.

4. The drive device according to claim 3, wherein the third flow path and the fourth flow path extend in a direction intersecting the axial direction.

5. The drive device according to claim 3, wherein a minimum flow-path cross-sectional area in the third flow path is wider than a minimum flow-path cross-sectional area in the fourth flow path.

6. The drive device according to claim 3, further comprising:
a refrigerant supply portion that has a tubular shape extending in the axial direction and is disposed radially outward of the stator and vertically above the rotation axis, wherein
an inside of the refrigerant supply unit is connected to the third flow path, and
the refrigerant supply portion has a refrigerant supply hole penetrating from an inner surface to an outer surface of the refrigerant supply portion and opening toward the outer surface of the stator.

7. The drive device according to claim 3, wherein
the shaft includes:
a shaft tubular portion extending in the axial direction;
a hollow portion surrounded by an inner surface of the shaft tubular portion to be connected to the fourth flow path; and
a shaft hole radially penetrating the shaft tubular portion,
the rotor includes a rotor core fixed to a radially outer surface of the shaft,
the rotor core has a rotor through hole that penetrates the rotor core in the axial direction and is connected to the shaft hole, and
the rotor through hole is connected to the fourth flow path via the hollow portion.

8. The drive device according to claim 1, wherein an end portion of the first flow path connected by the connection flow path and an end portion of the second flow path each face to each other with a gap therebetween.

9. The drive device according to claim 1, wherein
the housing includes a tubular connection member that connects the first flow path and the second flow path,
the connection flow path is a space surrounded by an inner surface of the connection member,
one end portion of the connection member is connected to the first flow path, and
the other end portion of the connecting member is connected to the second flow path.

10. The drive device according to claim 1, wherein
the housing includes a tubular connection member that connects the first flow path and the second flow path,
the connection flow path is a space surrounded by an inner surface of the connection member,
the connection flow path is integrated with one of the first flow path and the second flow path, and is connected to the other of the first flow path and the second flow path.

11. The drive device according to claim 1, further comprising:
an inverter unit that supplies drive power to the motor portion,
wherein the housing further includes:
a side plate portion that covers an other axial end portion of the first housing;
an inverter accommodation portion that accommodates the inverter unit;
a plate portion that extends from the first housing in a first direction perpendicular to the axial direction; and
a peripheral wall portion that surrounds the inverter accommodation portion when viewed from a second direction perpendicular to the axial direction and the first direction,
the inverter accommodation portion is a space surrounded by the first housing, the plate portion, and the peripheral wall portion, and
the first flow path is disposed in any one of the plate portion and the peripheral wall portion.

12. The drive device according to claim 11, further comprising:
the pump that supplies the refrigerant accommodated in the housing to the motor portion,
wherein the housing further includes a pump accommodation portion that accommodates the pump, and
the pump accommodation portion is formed in a peripheral wall portion that surrounds the inverter accommodation portion.
